(19) United States
(12) Patent Application Publication
(10) Pub. No.: US 2007/0190252 A1
(43) Pub. Date: Aug. 16, 2007

(54) Method for forming pattern, method for forming alignment film, droplet ejection apparatus, apparatus for forming alignment film, electro-optic device, and liquid crystal display

(75) Inventor: Yuji Iwata, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/705,255

(22) Filed: Feb. 12, 2007

(30) Foreign Application Priority Data
Feb. 13, 2006 (JP) 2006-034777
Jan. 10, 2007 (JP) 2007-002303

(51) Int. Cl. B05D 5/00; B05C 5/00

(52) U.S. Cl. 427/258; 118/300

(57) ABSTRACT

A method for forming a pattern on a substrate by ejecting droplets containing pattern forming material onto the substrate is disclosed. First droplets containing the pattern forming material are ejected in a first ejecting direction inclined with respect to a normal line of the substrate from a plurality of first ejection ports, which are aligned along a certain direction with respect to a surface of the substrate. Second droplets containing the pattern forming material are ejected in a second ejecting direction and onto areas between adjacent pairs of the first droplets on the substrate from a plurality of second ejection ports, which are aligned along the certain direction.

### CROSS-REFERENCE TO RELATED APPLICATIONS

This application is based upon and claims the benefit of priority from prior Japanese Patent Application Nos. 2006-034777 filed on Feb. 13, 2006, and 2007-002303 filed on Jan. 10, 2007, the entire contents of which are incorporated herein by reference.

### BACKGROUND

The present invention relates to a method for forming a pattern, a method for forming an alignment film, a droplet ejection apparatus, an apparatus for forming an alignment film, an electro-optic device, and a liquid crystal display.

A procedure for manufacturing a display or a semiconductor device includes a number of steps of forming a film pattern. Specifically, the film pattern is formed by depositing a film on a substrate and subjecting the film to patterning in a predetermined shape.

To improve productivity, this type of process for forming a pattern now employs an inkjet method. In the method, a film pattern is formed by ejecting droplets of liquid onto a substrate and solidifying the droplets on the substrate. The film pattern is thus formed on the substrate in correspondence with the shapes of the droplets. This makes it unnecessary to form a mask for patterning, thus decreasing the number of the steps for forming the pattern.

However, in formation of the film pattern by the inkjet method, some of the ejected droplets may not spread wet and form recesses and projections on the surface of the substrate. The film pattern reflects the recesses and projections, thus causing unevenness in the film pattern or non-uniform thicknesses of the film pattern.

To solve this problem, a method for promoting wet spreading of the droplets on the surface of the substrate has been proposed. As described in JP-A-2005-131498, droplets of liquid are ejected in a direction inclined with respect to a normal line of a substrate. This provides an element of velocity in a direction along the surface of the substrate to each of the ejected droplets. The droplets thus effectively spread wet along the surface of the substrate at an angle (an inclination angle) defined by the normal direction of the substrate and the ejecting direction of the droplets.

To change the thicknesses of the film pattern by the aforementioned inkjet method, the ejection amount of droplets per unit area is altered. In this case, as illustrated in FIG. 9, while maintaining the volume of each droplet Fc at a constant level, the ejection interval of the droplets Fc, or the ejection pitch W, is selectively increased and decreased. For example, to form a film pattern FP with a smaller thickness, the ejection pitch W of the droplets Fc is increased while maintaining the volumes of the droplets Fc at a constant level. Specifically, the relative velocity between a droplet ejection nozzle and the substrate Sb is increased or the time corresponding to a cycle of ejection is extended. This stabilizes ejection of droplets of liquid, ensuring sufficient reproducibility of the ejection amount, or the thickness of the film pattern.

However, if the ejecting direction A of the droplets Fc is inclined with respect to the normal direction (direction Z) of the substrate Sb, each of the ejected droplets Fc forms a substantially oval shape having a major axis extending in a direction (direction X) perpendicular to the normal direction of the substrate Sb and a minor axis extending in the alignment direction (direction Y) of nozzles N. This causes the following problem.

Since the thickness of each droplet Fc, which has the oval shape, is relatively small, the flowability of the droplet Fc is decreased. This reduces the thickness of a joint portion between each adjacent pair of the droplets Fc in the direction (direction Y) defined by the minor axis of the droplet Fc. An empty portion (a recess B) in which the droplet Fc is not provided is thus formed in each of the areas on the substrate Sb facing the spaces between each adjacent pair of the nozzles N. As a result, the thickness of the area of the film pattern FP corresponding to each recess B becomes extremely small, thus causing significant unevenness of the thickness of the film pattern FP.

### SUMMARY

Accordingly, it is an objective of the present invention to provide a method for forming a pattern, a droplet ejection apparatus, and an electro-optic device that increase uniformity of the thickness of a pattern formed by droplets.

It is another objective of the invention to provide a method for forming an alignment film, an apparatus for forming an alignment film, and a liquid crystal display that increase uniformity of the thickness of an alignment film formed by droplets of alignment film forming material.

In accordance with a first aspect of the present invention, a method for forming a pattern on a substrate by ejecting droplets containing a pattern forming material onto the substrate is provided. The method includes: ejecting, in a first ejecting direction inclined with respect to a normal line of the substrate, first droplets containing the pattern forming material from a plurality of first ejection ports that are aligned along a certain direction with respect to a surface of the substrate; and ejecting, in a second ejecting direction and onto areas between adjacent pairs of the first droplets on the substrate, second droplets containing the pattern forming material from a plurality of second ejection ports that are aligned along the certain direction.

In accordance with a second aspect of the present invention, a method for forming an alignment film on a substrate by ejecting droplets containing an alignment film forming material onto the substrate is provided. The method includes: ejecting, in a first ejecting direction inclined with respect to a normal line of the substrate, first droplets containing the alignment film forming material from a plurality of first ejection ports that are aligned along a certain direction with respect to a surface of the substrate; and ejecting, in a second ejecting direction and onto areas between adjacent pairs of the first droplets on the substrate, second droplets containing the alignment film forming material from a plurality of second ejection ports that are aligned along the certain direction.

In accordance with a third aspect of the present invention, a droplet ejection apparatus that forms a pattern on a substrate by ejecting droplets containing a pattern forming material onto the substrate is provided. The apparatus includes a first ejection port forming surface and a second ejection port forming surface. The first ejection port forming surface is opposed to the substrate. The first ejection port forming surface includes a plurality of first ejection ports that are aligned in a certain direction with respect to a surface of the substrate. Each of the first ejection ports ejects a first droplet containing the pattern forming material in a first ejecting direction inclined with respect to a normal line of the substrate. The second ejection port forming surface is opposed to the substrate. The second ejection port forming surface includes a plurality of second ejection ports that are aligned in the certain direction. Each of the second ejection ports ejects a second droplet containing the pattern forming material in a second ejecting direction and onto a corresponding one of areas between adjacent pairs of the first droplets on the substrate.

In accordance with a fourth aspect of the present invention, an electro-optic device that has a substrate having a pattern formed by the above described droplet ejection apparatus is provided.

In accordance with a fifth aspect of the present invention, an alignment film forming apparatus that forms an alignment film on a substrate by ejecting droplets containing an alignment film forming material onto the substrate is provided. The apparatus includes a first ejection port surface and a second ejection port forming surface. The first ejection port forming surface is opposed to the substrate. The first ejection port forming surface includes a plurality of first ejection ports that are aligned in a certain direction with respect to a surface of the substrate. Each of the first ejection ports ejects a first droplet containing the alignment film forming material in a first ejecting direction inclined with respect to a normal line of the substrate. The second ejection port forming surface is opposed to the substrate. The second ejection port forming surface includes a plurality of second ejection ports that are aligned in a certain direction with respect to a surface of the substrate. Each of the second ejection ports ejects a second droplet containing the alignment film forming material in a second ejecting direction and onto a corresponding one of areas between adjacent pairs of the first droplets on the substrate.

In accordance with a sixth aspect of the present invention, a liquid crystal display having a substrate including an alignment film formed by the above described alignment film forming apparatus is provided.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a liquid crystal display;

FIG. 2 is a cross-sectional view taken along line 2-2 of FIG. 1;

FIG. 3 is a perspective view showing a droplet ejection apparatus of FIG. 2;

FIG. 4 is a perspective view showing a droplet ejection head of the droplet ejection apparatus of FIG. 2;

FIG. 5 is a plan view showing the droplet ejection head of FIG. 4;

FIG. 6 is a side view showing the droplet ejection head of FIG. 4;

FIG. 7 is a view for explaining droplet ejection by the droplet ejection apparatus of FIG. 2;

FIG. 8 is a block diagram representing the electric configuration of the droplet ejection apparatus of FIG. 2; and

FIG. 9 is a side view schematically showing a conventional droplet ejection apparatus.

### DESCRIPTION OF EXEMPLARY EMBODIMENTS

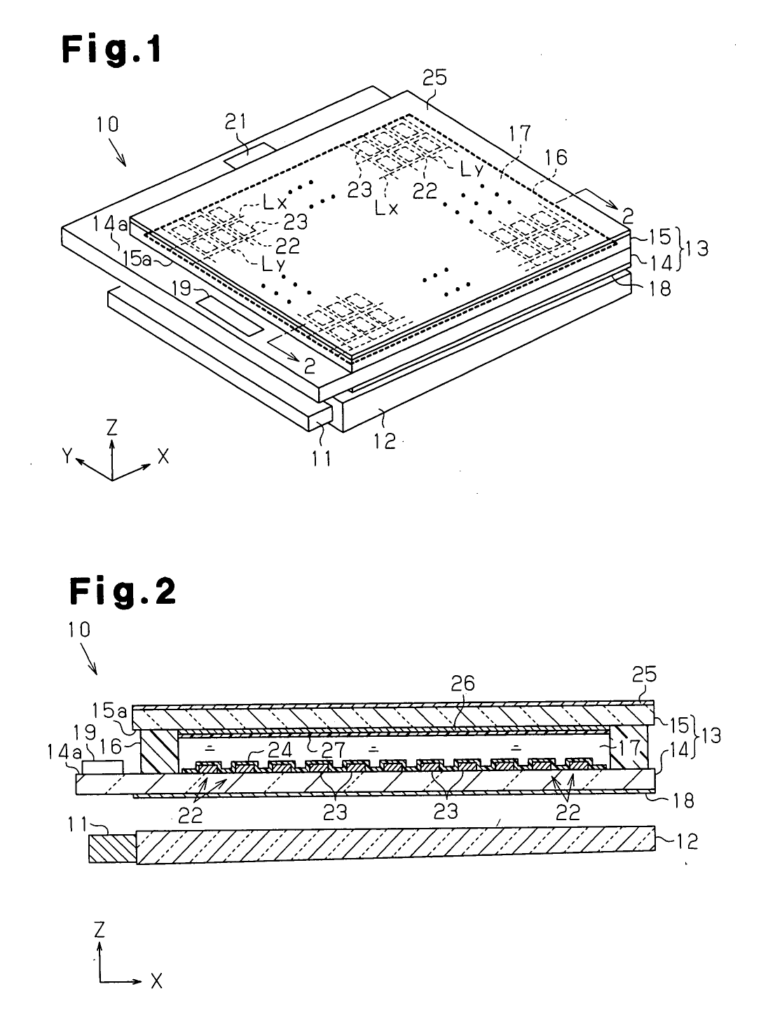

An embodiment of the present invention will now be described with reference to FIGS. 1 to 8. First, a liquid crystal display 10, or an electro-optic device, will be explained. The liquid crystal display 10 has an alignment film 27 formed by a method for forming a pattern according to the present invention. FIG. 1 is a perspective view showing the liquid crystal display 10 and FIG. 2 is a cross-sectional view taken along line 2-2 of FIG. 1.

As shown in FIG. 1, the liquid crystal display 10 has an edge light type backlight 12, which is shaped like a rectangular plate and has a light source 11 such as an LED. The backlight 12 is arranged in a lower portion of the liquid crystal display 10.

A liquid crystal panel 13, which is shaped like a rectangular plate and sized substantially equal to the size of the backlight 12, is provided above the backlight 12. The light emitted by the light source 11 is radiated onto the liquid crystal panel 13.

The liquid crystal panel 13 has an element substrate 14 and an opposed substrate 15 opposed to the element substrate 14. Referring to FIG. 2, the element substrate 14 and the opposed substrate 15 are bonded together through a seal material 16 having a rectangular frame-like shape and formed of light curing resin. Liquid crystal 17 is sealed in the space between the element substrate 14 and the opposed substrate 15.

An optical substrate 18, such as a polarizing plate or a phase difference plate, is bonded with the lower surface, or the surface facing the backlight 12, of the element substrate 14. The optical substrate 18 linearly polarizes the light of the backlight 12 and emits the light onto the liquid crystal 17. A plurality of scanning lines Lx, which extend in one direction, or direction X, are aligned on the upper surface (an element formation surface 14a), or the surface facing the opposed substrate 15, of the element substrate 14. Each of the scanning lines Lx is electrically connected to a scanning line driver circuit 19 provided on the element substrate 14. A scanning signal generated by the scanning line driver circuit 19 is input to the scanning lines Lx at a predetermined timing. A plurality of data lines Ly extending in direction Y are also aligned on the element formation surface 14a. Each of the data lines Ly is electrically connected to a data line driver circuit 21 formed on the element substrate 14. The data line driver circuit 21 inputs a data signal generated in accordance with display data to the data lines Ly at a predetermined timing.

A pixel 22 is formed in each of the portions defined on the element formation surface 14a by the scanning lines Lx and the data lines Ly, which intersect the scanning lines Lx. In other words, a plurality of pixels 22 are arranged on the element formation surface 14a in a matrix-like manner. A non-illustrated control element such as a TFT or a light transmissible pixel electrode 23 formed by a transparent conductive film is provided in each of the pixels 22.

As shown in FIG. 2, an alignment film 24 is deposited on the pixels 22. The alignment film 24 has been subjected to an orientation process through, for example, rubbing. The alignment film 24 is formed of alignment polymers such as alignment polyimide and sets the liquid crystals 17 in a prescribed alignment state in the vicinity of the pixel electrodes 23. The alignment film 24 is formed by the inkjet method. Specifically, pattern forming material prepared by dissolving the alignment polymers in a prescribed solvent, which is alignment film forming material F (see FIG. 6), is ejected onto each of the pixels 22 as a first droplet Fa or a second droplet Fb (FIG. 6). The first and second droplets Fa, Fb are then dried to form the alignment film 24.

A polarizing plate 25 is provided on the opposed substrate 15 and sends linear-polarized light proceeding perpendicularly to the light that has transmitted through the optical substrate 18 in an outward direction, or an upward direction as viewed in FIG. 2. An opposed electrode 26 is arranged on the entire portion of the lower surface (an electrode formation surface 15a), or the surface facing the element substrate 14, of the opposed substrate 15. The opposed electrode 26 is formed by a light transmissible conductive film and opposed to the pixel electrode 23. The opposed electrode 26 is electrically connected to the data line driver circuit 21 and receives a predetermined level of common potential from the data line driver circuit 21. An alignment film 27 is arranged on the entire portion of the lower surface of the opposed electrode 26. The alignment film 27 has been subjected to orientation procedure through, for example, rubbing. Like the alignment film 24, the alignment film 27 is formed using the inkjet method. The alignment film 27 sets the liquid crystal 17 in a prescribed alignment state in the vicinity of the opposed electrode 26.

In accordance with line progressive scanning, the scanning lines Lx are selected one by one at predetermined time intervals. The control element of the corresponding one of the pixels 22 is thus turned on for the period in which the scanning line Lx is selected. Respondingly, a data signal, which is generated in accordance with the display data, is input to the pixel electrode 23 corresponding to the control element through the corresponding one of the data lines Ly. This changes the difference between the potential of the pixel electrode 23 and the potential of the opposed electrode 26 in correspondence with the data signal. The alignment state of the liquid crystal 17 between the pixel electrode 23 and the opposed electrode 26 is thus altered. In other words, the polarized state of the light exiting the optical substrate 18 varies for the respective pixels 22 in correspondence with the data signals. Therefore, transmission of the light through the polarizing plate 25 is selectively permitted and prohibited for the respective pixels 22. This displays an image on the upper side of the liquid crystal panel 13 in accordance with the display data.

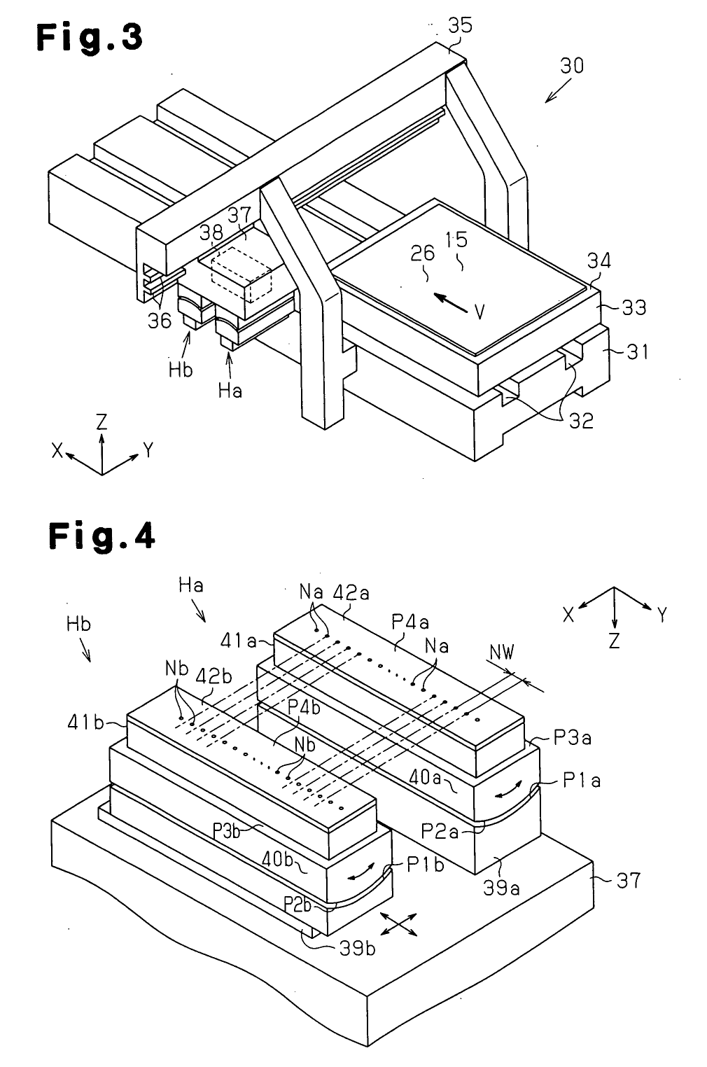

A droplet ejection apparatus 30, by which the alignment film 27 (the alignment film 24) is formed, will hereafter be explained with reference to FIGS. 3 to 8.

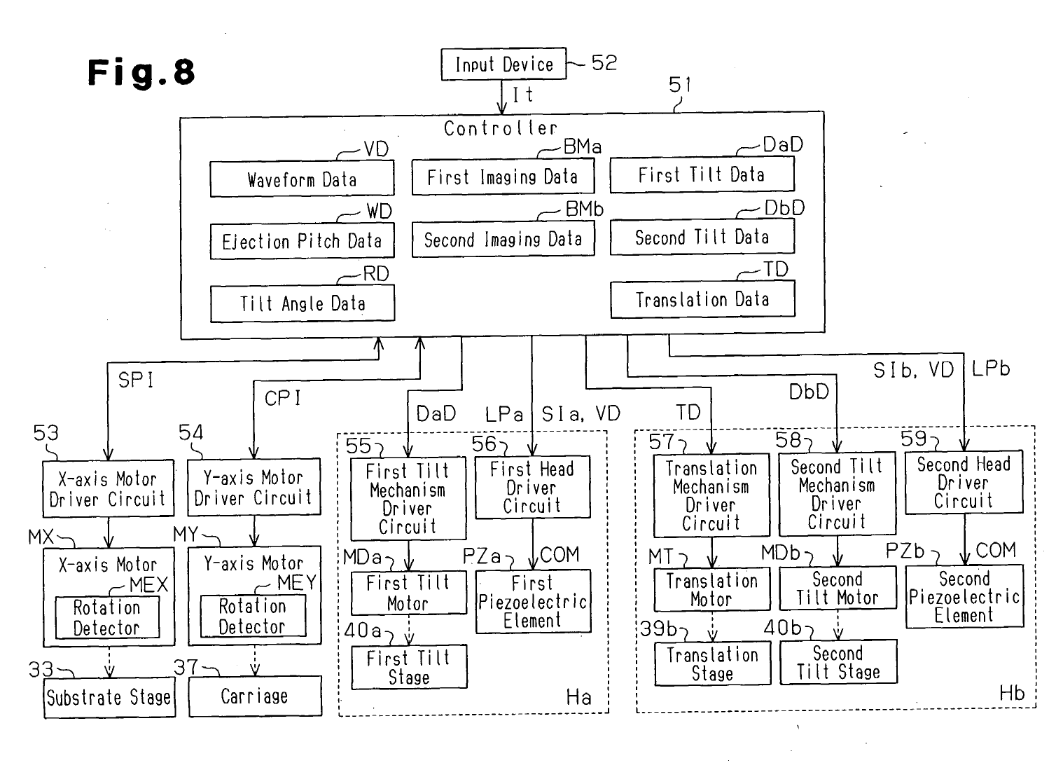

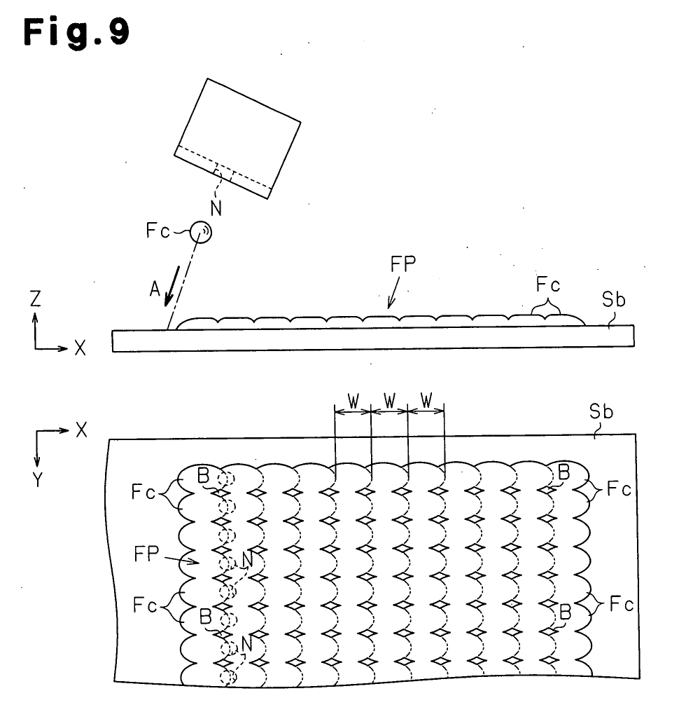

As shown in FIG. 3, the droplet ejection apparatus. 30, which is an apparatus for forming an alignment film in the illustrated embodiment, has a rectangular parallelepiped base 31. A pair of guide grooves 32 are defined in the upper surface of the base 31 and extend in the longitudinal direction of the base 31, or direction X. A substrate stage 33 is provided on the base 31 and operationally connected to the output shaft of an X-axis motor MX (see FIG. 8), which is arranged in the base 31. The substrate stage 33 moves along the guide grooves 32, or in direction X, at a predetermined velocity (transport velocity V).

The upper surface of the substrate stage 33 functions as a mounting surface 34 on which the opposed substrate 15 can be mounted. The mounting surface 34 positions and fixes the opposed substrate 15 with respect to the substrate stage 33. The opposed substrate 15 is mounted on the mounting surface 34 with the opposed electrode 26 facing upward. Although the opposed substrate 15 is mounted on the mounting surface 34 in the illustrated embodiment, the element substrate 14 may be mounted on the mounting surface 34 with the pixel electrodes 23 facing upward.

A gate-shaped guide member 35 straddles the base 31 and extends in direction Y. A pair of upper and lower guide rails 36 are formed in the guide member 35, extending in direction Y.

A carriage 37 is provided in the guide member 35 and operationally connected to the output shaft of a Y-axis motor MY (see FIG. 8), which is also arranged in the guide member 35. The carriage 37 moves in direction Y and the direction opposed to direction Y along the guide rails 36. An ink tank 38 is mounted in the carriage 37 and retains the alignment film forming material F (see FIG. 6). The alignment film forming material F can be sent from the ink tank 38 to a first head unit Ha and a second head unit Hb, which are arranged on the lower surface of the carriage 37.

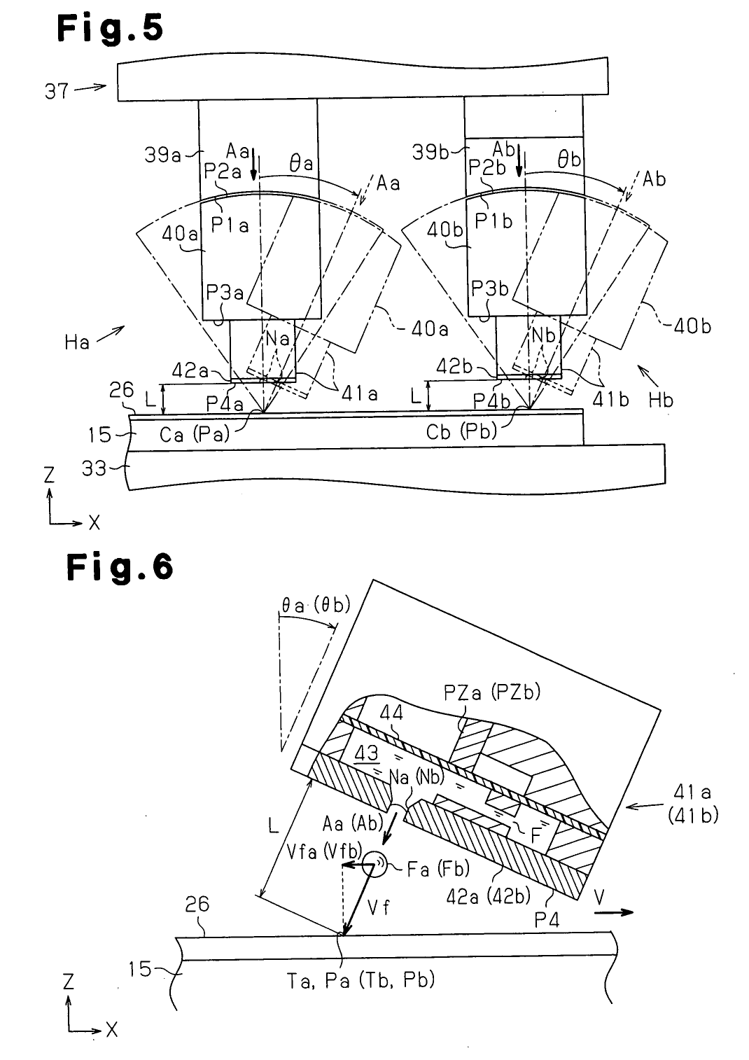

FIG. 4 is a perspective view schematically showing the first head unit Ha and the second head unit Hb as viewed from below, or the side corresponding to the opposed substrate 15. FIG. 5 is a side view schematically showing the first head unit Ha and the second head unit Hb as viewed in direction Y.

As shown in FIG. 4, the first head unit Ha and the second head unit Hb are arranged on the lower side, or the upper side as viewed in FIG. 4, of the carriage 37 and aligned in direction X. The first head unit Ha and the second head unit Hb have a support stage 39a and a translation stage 39b, respectively. The support stage 39a and the translation stage 39b each have a rectangular parallelepiped shape and extend in direction Y.

A first guide surface P1a, which is a recessed surface having an arcuate cross section, is formed on the lower surface, or the upper surface in FIG. 4, of the support stage 39a. The first guide surface P1a extends substantially along the entire width of the support stage 39a and in direction Y. The center of curvature Ca (see FIG. 5) of the first guide surface P1a is located at a position immediately below the support stage 39a and on the upper surface of the opposed electrode 26 mounted on the substrate stage 33.

A second guide surface P1b, which is a recessed surface having an arcuate cross section, is formed on the lower surface, or the upper surface as viewed in FIG. 4, of the translation stage 39b. The translation stage 39b is an XY stage that allows the second guide surface P1b to translate in direction X and direction Y. The translation stage 39b is operationally connected to the output shaft of a translation motor MT (see FIG. 8), which is housed in the carriage 37. When receiving the drive force of the translation motor MT, the translation stage 39b translates the second guide surface P1b in direction X and direction Y. Like the first guide surface P1a, the center of curvature Cb (see FIG. 5) of the second guide surface P1b is located at the position immediately below the translation stage 39b and on the upper surface of the opposed electrode 26 mounted on the substrate stage 33.

Referring to FIG. 4, a first tilt stage 40a, which forms a first tilt mechanism, is provided on the first guide surface P1a of the support stage 39a and extends in direction Y. A second tilt stage 40b, which forms a second tilt mechanism, is provided on the second guide surface P1b of the translation stage 39b and extends in direction Y.

The first tilt stage 40a has a first slide surface P2a and a first securing surface P3a. The first slide surface P2a is provided on the surface of the first tilt stage 40a facing the carriage 37, or the lower surface of the first tilt stage 40a as viewed in FIG. 4, and forms a projecting surface shaped in correspondence with the shape of the first guide surface P1a. The first securing surface P3a is arranged on the surface of the first tilt stage 40a opposed to the first slide surface P2a, or the upper surface of the first tilt stage 40a as viewed in FIG. 4. The first securing surface P3a extends along and parallel with the opposed substrate 15.

Similarly, the second tilt stage 40b has a second slide surface P2b and a second securing surface P3b. The second slide surface P2b is provided on the surface of the second tilt stage 40b facing the carriage 37, or the lower surface of the second tilt stage 40b as viewed in FIG. 4, and forms a projecting surface shaped in correspondence with the shape of the second guide surface P1b. The second securing surface P3b is arranged on the surface of the second tilt stage 40b opposed to the second slide surface P2b, or the upper surface in FIG. 4. The second securing surface P3b extends along and parallel with the opposed substrate 15.

The first tilt stage 40a and the second tilt stage 40b are operationally connected to the output shaft of a first tilt motor MDa and the output shaft of a second tilt motor MDb (see FIG. 8), respectively. The first and second tilt motors MDa, MDb are housed in the carriage 37. When receiving the drive force of the first tilt motor MDa, the first tilt stage 40a causes the first slide surface P2a to slide (pivot) along the first guide surface P1a. When receiving the drive force of the second tilt motor MDb, the second tilt stage 40b causes the second slide surface P2b to slide (pivot) along the second guide surface P1b.

In other words, the first tilt stage 40a tilts the corresponding first securing surface P3a with respect to the opposed substrate 15 about the tilt axis (a first tilt axis) that includes the center of curvature Ca located on the opposed electrode 26, which is the pivotal axis, in such a manner that the first slide surface P2a and the first guide surface P1a are arranged on a common plane.

Further, the second tilt stage 40b tilts the corresponding second securing surface P3b with respect to the opposed substrate 15 about the tilt axis (a second tilt axis) that includes the center of curvature Cb located on the opposed electrode 26, or the pivotal axis, in such a manner that the second slide surface P2b and the second guide surface P1b are arranged on a common plane.

When a signal that instructs tilting of the first securing surface P3a is provided to the first tilt motor MDa, the first tilt motor MDa is rotated in a forward direction or a reverse direction by a predetermined number of rotations. This tilts the first securing surface P3a of the first tilt stage 40a about the center of curvature Ca. When a signal that instructs tilting of the second securing surface P3b is provided to the second tilt motor MDb, the second tilt motor MDb is rotated in a forward direction or a reverse direction by a predetermined number of rotations. This tilts the second securing surface P3b of the second tilt stage 40b about the center of curvature Cb.

In the illustrated embodiment, when the first tilt stage 40a is oriented in such a manner that a normal direction of the first securing surface P3a (hereinafter, referred to as a first ejecting direction Aa) extends parallel with a normal direction of the opposed substrate 15 (direction Z), as indicated by the solid lines of FIG. 5, it is defined that the first tilt stage 40a is located at an initial position. When the first tilt stage 40a is oriented in such a manner that the first ejecting direction Aa is tilted clockwise with respect to direction Y at a predetermined angle (a first tilt angle θa), as indicated by the two-dotted chain lines of FIG. 5, it is defined that the first tilt stage 40a is located at a tilt position.

Further, when the second tilt stage 40b is oriented in such a manner that a normal direction of the second securing surface P3b (hereinafter, referred to as a second ejecting direction Ab) extends parallel with a normal direction of the opposed substrate 15 (direction Z), as indicated by the solid lines of FIG. 5, it is defined that the second tilt stage 40b is located at an initial position. When the second tilt stage 40b is oriented in such a manner that the second ejecting direction Ab is tilted clockwise with respect to direction Z at a predetermined angle (a second tilt angle θb), as indicated by the two-dotted chain lines of FIG. 5, it is defined that the second tilt stage 40b is located at a tilt position.

As shown in FIG. 4, a first droplet ejection head (hereinafter, referred to simply as a first ejection head) 41a, which extends in direction Y and has a rectangular parallelepiped shape, is secured to the first securing surface P3a. A second droplet ejection head (hereinafter, referred to simply as a second ejection head) 41b, which extends in direction Y and has a rectangular parallelepiped shape, is secured to the second securing surface P3b. A first nozzle plate 42a is provided at the lower side (the upper side as viewed in FIG. 4) of the first ejection head 41a, and a second nozzle plate 42b is arranged at the lower side (the upper side as viewed in FIG. 4) of the second ejection head 41b. A first nozzle-forming surface P4a (a first ejection port surface) parallel with the first securing surface P3a is formed at the side (the upper side as viewed in FIG. 4) of the first nozzle plate 42a closer to the opposed substrate 15. A plurality of first nozzles Na, each serving as a first ejection port, are aligned on the first nozzle-forming surface P4a and in direction Y at a constant pitch (nozzle pitch NW).

Likewise, a second nozzle-forming surface P4b (a second ejection port surface) parallel with the second securing surface P3b is formed at the side (the upper side as viewed in FIG. 4) of the second nozzle plate 42b closer to the opposed substrate 15. A plurality of second nozzles Nb, each serving as a second ejection port, are aligned on the second nozzle-forming surface P4b and in direction Y at a constant pitch (nozzle pitch NW).

In FIG. 4, the translation stage 39b is translated in such a manner that, as viewed in direction X, the positions of the second nozzles Nb become offset from the positions of the corresponding first nozzles Na in direction Y by the distance corresponding to a half of the nozzle pitch NW.

In FIG. 5, the first nozzles Na are arranged in such a manner as to extend in a normal direction of the first nozzle-forming surface P4a, or along the first ejecting direction Aa. The second nozzles Nb are provided in such a manner as to extend in a normal direction of the second nozzle-forming surface P4b, or along the second ejecting direction Ab.

The first nozzles Na are provided in such a manner that, when the first tilt stage 40a is located at the initial position, the first nozzles Na are arranged forward in direction Z (rearward in the first ejecting direction Aa) with respect to the center of curvature Ca. The second nozzles Nb are provided in such a manner that, when the second tilt stage 40b is located at the initial position, the second nozzles Nb are arranged forward in direction Z (rearward in the second ejecting direction Ab) with respect to the center of curvature Cb.

In the illustrated embodiment, the position on the center of curvature Ca and forward from each of the first nozzles Na in the first ejecting direction Aa is defined as a first droplet receiving position Pa. The position on the center of curvature Cb and forward from each of the second nozzles Nb in the second ejecting direction Ab is defined as a second droplet receiving position Pb.

As the first tilt motor MDa (the second tilt motor MDb) rotates in the forward direction, the first tilt stage 40a (the second tilt stage 40b) moves from the initial position to the tilt position. This causes pivoting of the first nozzles Na (the second nozzles Nb) clockwise about the corresponding first droplet receiving positions Pa (the corresponding second droplet receiving positions Pb), as illustrated in FIG. 6. As a result, the extending direction of each first nozzle Na (each second nozzle Nb), or the first ejecting direction Aa (the second ejecting direction Ab), becomes tilted at the first tilt angle ea (the second tilt angle θb) with respect to a normal direction of the opposed substrate 15 (direction Z). This maintains the distance from each first nozzle Na (each second nozzle Nb) to the corresponding first droplet receiving position Pa (the corresponding second droplet receiving position Pb) as a predetermined traveling distance L. That is, the accuracy of reception of the first droplets Fa (the second droplets Fb) that have been ejected from the first nozzles Na (the second nozzles Nb) is maintained regardless of change of the first ejecting direction Aa (the second ejecting direction Ab).

Referring to FIG. 6, the first ejection head 41a (the second ejection head 41b) has cavities 43 each of which communicates with the corresponding one of the first nozzles Na (the corresponding one of the second nozzles Nb) and the ink tank 38. The alignment film forming material F is supplied from the ink tank 38 to the corresponding one of the first nozzles Na (the corresponding one of the second nozzles Nb) through each of the cavities 43. The first ejection head 41a (the second ejection head 41b) has oscillation plates 44, which are provided in correspondence with the cavities 43. Each of the oscillation plates 44 is capable of oscillating in the first ejecting direction Aa (the second ejecting direction Ab) and the direction opposed to the first ejecting direction Aa (the direction opposed to the second ejecting direction Ab). This increases and decreases the volume of the corresponding cavity 43. First piezoelectric elements PZa (second piezoelectric elements PZb) are arranged on the oscillation plates 44 in correspondence with the first nozzles Na (the second nozzles Nb). Each of the first piezoelectric elements PZa (each of the second piezoelectric elements PZb) contracts and extends in response to a piezoelectric element drive signal COM (see FIG. 8). This oscillates the corresponding one of the oscillation plates 44.

Specifically, the first tilt motor MDa (the second tilt motor MDb) is driven to move the first tilt stage 40a (the second tilt stage 4.0b) to the predetermined tilt position. Piezoelectric element drive signals COM are then provided to the prescribed ones of the first piezoelectric elements PZa (the prescribed ones of the second piezoelectric elements PZb). This increases and decreases the volume of each of the cavities 43 corresponding to the first piezoelectric elements PZa (the second piezoelectric elements PZb), oscillating the interface, which is meniscus, of the alignment film forming material F in each of the corresponding first nozzles Na (the corresponding second nozzles Nb). Respondingly, as illustrated in FIG. 6, a predetermined weight of alignment film forming material F is ejected from the first nozzles Na (the second nozzles Nb) as the first droplets Fa (the second droplets Fb) in correspondence with the piezoelectric element drive signals COM. Each of the first droplets Fa (each of the second droplets Fb) then flies in the direction defined by the corresponding one of the first nozzles Na (the corresponding one of the second nozzles Nb), or the first ejecting direction Aa (the second ejecting direction Ab), at a predetermined ejection velocity Vf. The first droplets Fa (the second droplets Fb) thus reach the corresponding first droplet receiving positions Pa (the corresponding second droplet receiving positions Pb) on the opposed electrode 26.

When flying at the ejection velocity Vf, each of the first droplets Fa (each of the second droplets Fb) receives a first tangential velocity Vfa (a second tangential velocity Vfb) as a velocity component in the direction opposed to direction X. Further, the substrate stage 33 moves in direction X at the predetermined transport velocity V and each first droplet Fa (each second droplet Fb) flies onto the opposed electrode 26. This substantially applies an additional velocity component corresponding to the transport velocity V to the first droplet Fa (the second droplet Fb) as a velocity component in the direction opposed to direction X. The first droplet Fa (the second droplet Fb) thus spreads wet from the first droplet receiving position Pa (the second droplet receiving position Pb) in the direction opposed to direction X at a velocity determined by the sum of the first tangential velocity Vfa (the second tangential velocity Vfb) and the velocity component corresponding to the transport velocity V.

Thus, each of the first droplets Fa forms a shape in correspondence with the first ejecting direction Aa (the tilt angle θa) and each of the second droplets Fb forms a shape in correspondence with the second ejecting direction Ab (the tilt angle θb).

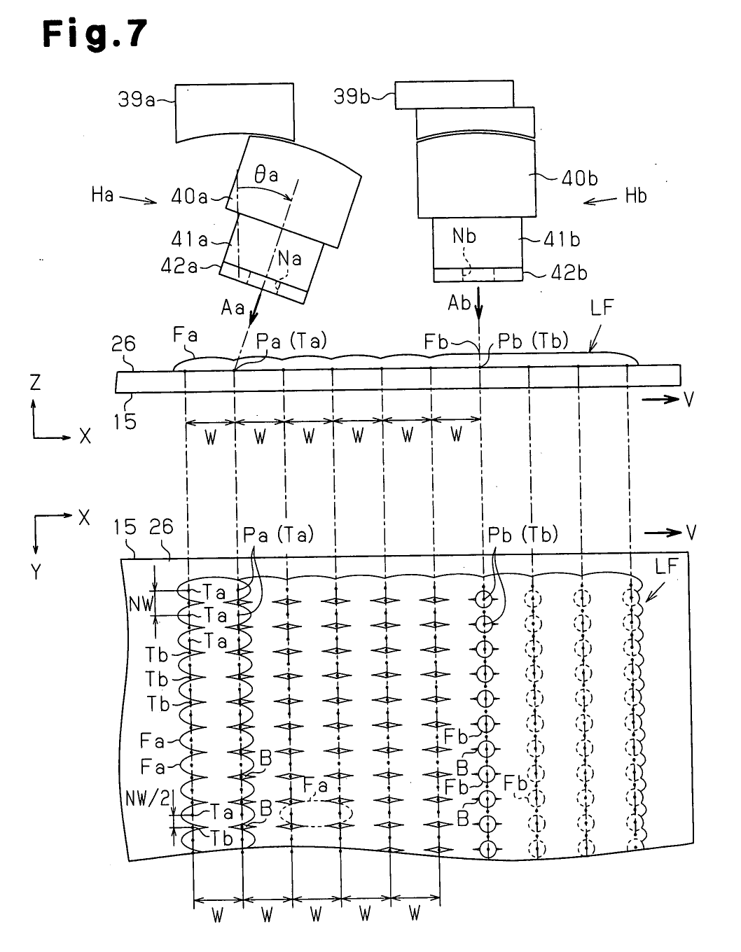

As illustrated in FIG. 7, grid points (first target positions Ta) for receiving first droplets Fa and grid points (second target positions Tb) for receiving second droplets Fb are set in the area of the opposed electrode 26 in which the alignment film 27 is to be formed.

Specifically, the first target positions Ta are set in such a manner that the interval between each adjacent pair of the first target positions Ta in direction Y becomes equal to the nozzle pitch NW and the interval between each adjacent pair of the first target positions Ta in direction X becomes a predetermined value (ejection pitch W). The second target positions Tb are each set at the position spaced from the corresponding first target position Ta in direction Y by the distance corresponding to a half of the nozzle pitch NW.

The ejection pitch W is set in such a manner that a target ejection amount of first or second droplet Fa, Fb is ejected onto the area in which the alignment film 27 is to be formed. The target ejection amount of each droplet Fa, Fb is determined from a target thickness of the alignment film 27 and the volume of the droplet Fa, Fb.

Subsequently, the Y-axis motor MY is driven to adjust the position of the carriage 37 in such a manner that, when the opposed substrate 15 is transported in direction X, each first droplet receiving position Pa moves on the path defined by the corresponding first target position Ta. Further, the translation motor MT is driven to adjust the position of the translation stage 39b in such a manner that, when the opposed substrate 15 is transported in direction X, each second droplet receiving position Pb moves on the path defined by the corresponding second target position Tb.

The first tilt motor MDa is driven to arrange the first tilt stage 40a at the predetermined tilt position. The second tilt motor MDb is driven to arrange the second tilt stage 40b at the predetermined initial position.

The tilt position (the tilt angle θa) of the first tilt stage 40a is set in advance in such a manner that the diameter of each first droplet Fa received by the opposed electrode 26 in direction X becomes greater than the ejection pitch W and the diameter of the first droplet Fa received by the opposed electrode 26 in direction Y becomes greater than the nozzle pitch NW, based on tests or the like.

Then, the X-axis motor MX is driven to transport the substrate stage 33 (the opposed electrode 26) in direction X. In this state, each time the first target positions Ta reach the corresponding first droplet receiving positions Pa, the piezoelectric element drive signals COM are provided to the corresponding first piezoelectric elements PZa.

This causes ejection of the first droplets Fa from the corresponding first nozzles Na and the first droplets Fa sequentially reach the corresponding first target positions Ta, referring to FIG. 7. Each of the first droplets Fa then spreads in the direction corresponding to the first ejecting direction Aa (the tilt angle θa), thus forming an oval shape extending in direction X. In this state, the thickness of each first droplet Fa is relatively small and thus the flowability of the first droplet Fa becomes relatively low. This decreases the thickness of each first droplet Fa in a portion in the direction defined by the minor axis of the first droplet Fa (direction Y). Accordingly, a substantially rhomboidal empty recess B, in which the first droplet Fa is not provided, is defined in an area between each adjacent pair of the first droplets Fa in direction Y, or an area corresponding to a second target position Tb.

Each time the second target positions Tb reach the corresponding second droplet receiving positions Pb, the piezoelectric element drive signals COM are sent to the corresponding second piezoelectric elements PZb.

This causes ejection of the second droplets Fb from the corresponding second nozzles Nb and the second droplets Fb sequentially reach the corresponding second target positions Tb, referring to FIG. 7. Each of the second droplets Fb then forms a semispherical shape about the corresponding one of the second target positions Tb in such a manner as to cover the corresponding one of the recess B. In this state, each second droplet Fb exhibits relatively high flowability, thus evening the portion of the associated first droplet Fa corresponding to and in the vicinity of the recess B. Accordingly, since the second droplets Fb are provided in correspondence with the recesses B, the first and second droplets Fa, Fb form a liquid film LF having a uniform thickness on the opposed electrode 26.

The electric configuration of the droplet ejection apparatus 30, which is constructed as above-described, will be explained with reference to FIG. 8.

As illustrated in FIG. 8, a controller 51, which forms a first tilt information generating section and a second tilt information generating section, has a CPU, a RAM, and a ROM, which form a control section. In accordance with various types of data and programs stored in the RAM or the ROM, the controller 51 moves the substrate stage 33 and the carriage 37 and controls operation of the first head unit Ha and the second head unit Hb.

The controller 51 stores waveform data VD, ejection pitch data WD, tilt angle data RD, first imaging data BMa, second imaging data BMb, first tilt data DaD, second tilt data DbD, and translation data TD.

The waveform data VD regulates the waveforms of the voltages of the piezoelectric element drive signals COM, each of which is provided to the corresponding one of the first piezoelectric elements PZa and the second piezoelectric elements PZb. The waveform data VD is set in advance through tests or the like in such a manner that the weight of each of the first and second droplets Fa, Fb stably becomes a predetermined value.

The ejection pitch data WD is used for determining the ejection pitch W in correspondence with the target thickness of the alignment film 27. The ejection pitch data WD is set in such a manner that the amount of each of the first and second droplets Fa, Fb ejected at the ejection pitch W becomes equal to the target ejection amount, which is obtained from the target thickness of the alignment film 27.

The tilt angle data RD is used for determining the first tilt angle θa and the second tilt angle θb in correspondence with the ejection pitch W. The tilt angle data RD is set in advance through tests or the like in such a manner that, when each first droplet Fa is received by the opposed electrode 26 at the first tilt angle θa, the major axis of the first droplet Fa becomes longer than the ejection pitch W and the minor axis of the first droplet Fa becomes longer than the nozzle pitch NW. The tilt angle data RD also relates to the second tilt angle θb, which is set to shape each of the ejected second droplets Fb to cover the corresponding recess B.

The first imaging data MBa and the second imaging data BMb each associate a bit value (0 or 1) with each of the grid points on the opposed electrode 26 including the first target positions Ta and the second target positions Tb. That is, the data instructs whether to excite or de-excite the respective one of the first and second piezoelectric elements PZa, PZb in accordance with the associated bit value. Specifically, in accordance with the first imaging data BMa, ejection of the first droplets Fa is performed each time the first droplet receiving positions Pa are located at the corresponding first target positions Ta. In accordance with the second imaging data BMb, ejection of the second droplets Fb is performed each time the second droplet receiving positions Pb are located at the corresponding second target positions Tb.

The first tilt data DaD associates the first tilt angle θa with the number of rotations of the first tilt motor MDa. The first tilt data DaD is used in actuation of the first tilt motor MDa in correspondence with the first tilt angle θa. Similarly, the second tilt data DbD associates the second tilt angle θb with the number of rotations of the second tilt motor MDb. The second tilt data DaD is used in actuation of the second tilt motor MDb in correspondence with the second tilt angle θb.

The translation data TD associates the amount of translation of the second ejection head 41b (the second nozzles Nb) with the number of rotations of the translation motor MT. The translation data TD is used in translation of the second ejection head 41b. In the illustrated embodiment, the translation data TD is set in such a manner that the position of each second nozzle Nb, as viewed in direction Y, becomes offset from the adjacent one of the first nozzles Na in direction Y by the distance corresponding to a half of the nozzle pitch NW.

An input device 52, an X-axis motor driver circuit 53, a Y-axis motor driver circuit 54, a first tilt mechanism driver circuit 55, a first head driver circuit 56, a translation mechanism driver circuit 57, a second tilt mechanism driver circuit 58, and a second head driver circuit 59 are connected to the controller 51.

The input device 52 has manipulation switches such as a start switch and a stop switch, and sends different manipulation signals to the controller 51. The input device 52 also provides information regarding the target thickness of the alignment film 27 to the controller 51 as a prescribed form of film thickness information It. In correspondence with the film thickness information It provided by the input device 52, the controller 51 calculates the ejection pitch W corresponding to the target thickness, or the position coordinates of each first target position Ta and the corresponding second target position Tb. Then, in correspondence with the obtained position coordinates, the controller 51 generates and stores the first imaging data BMa, the second imaging data BMb, the first tilt data DaD, and the second tilt data DbD, which are necessary for ejecting the first droplets Fa and the second droplets Fb.

The X-axis motor driver circuit 53 receives a corresponding drive signal from the controller 51 and, in response to the signal, drives the X-axis motor MX to rotate in a forward or reverse direction. A rotation detector MEX is provided in the X-axis motor MX and sends a detection signal to the X-axis motor driver circuit 53. In correspondence with the detection signal, the X-axis motor driver circuit 53 calculates the movement direction and the movement amount of the substrate stage 33 (the opposed substrate 15) and generates information representing the current position of the substrate stage 33 as substrate position information SPI. The controller 51 receives the substrate position information SPI from the X-axis motor driver circuit 53 and outputs various types of signals.

The Y-axis motor driver circuit 54 receives a corresponding drive signal from the controller 51 and, in response to the signal, drives the Y-axis motor MX to rotate in a forward or reverse direction. A rotation detector MEY is provided in the Y-axis motor MY and provides a detection signal to the Y-axis motor driver circuit 54. In correspondence with the detection signal, the Y-axis motor driver circuit 54 calculates the movement direction and the movement amount of the carriage 37 (the first head unit Ha and the second head unit Hb) and generates information representing the current position of the carriage 37 as carriage position information CPI. The controller 51 receives the carriage position information CPI from the Y-axis motor driver circuit 54 and outputs various types of drive signals.

Specifically, before the opposed substrate 15 reaches the position immediately below the carriage 37, the controller 51 generates the first imaging data BMa corresponding to a single (forward or reverse) scanning cycle of the opposed substrate 15 based on the substrate position information SPI and the carriage position information CPI. The controller 51 also generates first ejection control signals SIa synchronized with a prescribed clock signal using the first imaging data BMa. Further, from the second imaging data BMb corresponding to a single (forward or reverse) scanning cycle of the opposed substrate 15, the controller 51 produces second ejection control signals SIb synchronized with a prescribed clock signal.

Then, in each of the scanning cycles of the opposed substrate 15 by the carriage 37 in movement, the controller 51 serially transfers the first ejection control signals SIa and the second ejection control signals SIb to the first head driver circuit 56 and the second head driver circuit 59, respectively.

Further, each time the first droplet receiving positions Pa are located at the first target positions Ta, the controller 51 generates first ejection timing signals LPa, each of which instructs excitement of the corresponding one of the first piezoelectric elements PZa, in correspondence with the substrate position information SPI. Likewise, each time the second droplet receiving positions Pb are located at the second target positions Tb, the controller 51 generates second ejection timing signals LPb, each of which instructs excitement of the corresponding one of the second piezoelectric elements PZb, in correspondence with the substrate position information SPI. The controller 51 then sequentially sends the first ejection timing signals LPa and the second ejection timing signals LPb to the first head driver circuit 56 and the second head driver circuit 59, respectively.

In response to reception of the first tilt data DaD from the controller 51, the first tilt mechanism driver circuit 55 drives the first tilt motor MDa to rotate in a forward or reverse direction.

The first piezoelectric elements PZa are connected to the first head driver circuit 56. The controller 51 provides the waveform data VD, the first ejection control signals SIa, and the first ejection timing signals LPa to the first head driver circuit 56. In response to the first ejection control signals SIa, the first head driver circuit 56 sequentially converts the first ejection control signals SIa from serial forms into parallel forms in correspondence with the first piezoelectric elements PZa. Then, each time the controller 51 inputs the first ejection timing signal LPa to the first head driver circuit 56, the first head driver circuit 56 provides the piezoelectric element drive signals COM to the selected ones of the first piezoelectric elements PZa in correspondence with the first ejection control signals SIa, which have been converted into the parallel forms. In other words, each time the first droplet receiving positions Pa reach the first target positions Ta, the first head driver circuit 56 provides the piezoelectric element drive signals COM to the corresponding ones of the first piezoelectric elements PZa.

In response to reception of the translation data TD from the controller 51, the translation mechanism driver circuit 57 drives the translation motor MT to rotate in a forward or reverse direction. In response to reception of the second tilt data DbD from the controller 51, the second tilt mechanism driver circuit 58 drives the second tilt motor MDb to rotate in a forward or reverse direction.

The second piezoelectric elements PZb are connected to the second head driver circuit 59. The controller 51 provides the waveform data VD, the second ejection control signals SIb, and the second ejection timing signals LPb to the second head driver circuit 59. In response to the second ejection control signals SIb, the second head driver circuit 59 sequentially converts the second ejection control signals SIb from serial forms into parallel forms in correspondence with the second piezoelectric elements PZb. Then, each time the controller 51 inputs the second ejection timing signal LPb to the second head driver circuit 59, the second head driver circuit 59 provides the piezoelectric element drive signals COM to the selected ones of the second piezoelectric elements PZb in correspondence with the second ejection control signals SIb, which have been converted into the parallel forms. In other words, each time the second droplet receiving positions Pb reach the second target positions Tb, the second head driver circuit 59 provides the piezoelectric element drive signals COM to the corresponding ones of the second piezoelectric elements PZb.

A method for forming the alignment film 27 on the opposed substrate 15 using the droplet ejection apparatus 30, which has been described so far, will hereafter be explained.

First, as illustrated in FIG. 3, the opposed substrate 15 is mounted on the substrate stage 33. Specifically, at this stage, the substrate stage 33 is located rearward from the carriage 37 in direction X. The carriage 37 is arranged at the rearmost position of the guide member 35 in direction Y.

In this state, the film thickness information It is input to the controller 51 by manipulating the input device 52. Then, with reference to the ejection pitch data WD, the controller 51 calculates the ejection pitch W, or the position coordinates of each first target position Ta and the corresponding second target position Tb, in correspondence with the film thickness information It (the target thickness). Further, based on the obtained position coordinates, the controller 51 generates and stores the first imaging data BMa, the second imaging data BMb, the first tilt data DaD, and the second tilt data DbD.

In accordance with the first tilt data DaD, the controller 51 sets the first tilt stage 40a at the tilt position based on the first tilt data DaD through the first tilt mechanism driver circuit 55. In accordance with the second tilt data DbD, the controller 51 sets the second tilt stage 40b at the initial position based on the second tilt data DbD through the second tilt mechanism driver circuit 58. Subsequently, the controller 51 sets the translation stage 39b through the translation mechanism driver circuit 57 in such a manner that the position of each second nozzle Nb becomes offset from the corresponding first nozzle Na in direction Y by the distance corresponding to a half of the nozzle pitch NW.

After having set the first tilt stage 40a, the second tilt stage 40b, and the translation stage 39b, the controller 51 operates the Y-axis motor MY to set the carriage 37 in such a manner that, when the opposed substrate 15 is transported in direction X, the first droplet receiving positions Pa and the second droplet receiving positions Pb are each arranged at a position on the path defined by the corresponding one of the first target positions Ta and the second target positions Tb. The controller 51 then drives the X-axis motor MX to start movement of the substrate stage 33 (the opposed substrate 15) in direction X.

At this stage, the controller 51 outputs the waveform data VD to the first head driver circuit 56 and the second head driver circuit 59 in synchronization with the prescribed clock signal. Further, the controller 51 produces the first ejection control signals SIa and the second ejection control signals SIb by synchronizing the first imaging data BMa and the second imaging data BMb, respectively, corresponding to a single cycle of scanning of the opposed substrate 15 with a prescribed clock signal. The controller 51 then serially transfers the first ejection control signals SIa to the first head driver circuit 56 and the second ejection control signals SIb to the second head driver circuit 59.

Each time the first droplet receiving positions Pa reach the corresponding first target positions Ta, the controller 51 sends the first ejection timing signals LPa to the first head driver circuit 56 in accordance with the substrate position information SPI and the carriage position information CPI. Each time the second droplet receiving positions Pb reach the corresponding second target positions Tb, the controller 51 sends the second ejection timing signals LPb to the second head driver circuit 59.

After having output the first ejection timing signals LPa, the controller 51 performs droplet ejection through the first head driver circuit 56 in correspondence with the first ejection control signals SIa. In other words, each time the first droplet receiving positions Pa reach the corresponding first target positions Ta, the controller 51 provides the piezoelectric element drive signals COM to the corresponding first piezoelectric elements PZa, thus ejecting the first droplets Fa from the associated first nozzles Na. The first droplets Fa then sequentially reach the corresponding first target positions Ta and spread in a direction corresponding to the first ejecting direction Aa (the tilt angle θa). This defines the recesses B in the areas corresponding to the second target positions Tb.

After having output the second ejection timing signals LPb, the controller 51 performs droplet ejection through the second head driver circuit 59 in correspondence with the second ejection control signals SIb. In other words, each time the second droplet receiving positions Pb reach the corresponding second target positions Tb (the areas corresponding to the recesses B), the controller 51 provides the piezoelectric element drive signals COM to the corresponding second piezoelectric elements PZb, thus ejecting the second droplets Fb from the associated second nozzles Nb. The second droplets Fb then sequentially reach the corresponding second target positions Tb, or the areas corresponding to the recesses B. Each of the second droplets Fb then forms a semispherical shape in such a manner as to cover the corresponding one of the recesses B, thus filling the recesses B. This provides the liquid film LF having uniform thickness, and the alignment film 27 having uniform thickness is formed by drying the liquid film LF.

After the alignment film 27 is formed on the opposed substrate 15, a known rubbing process is performed on the alignment film 27. Further, by a method similar to the above-described method, the alignment film 24 is deposited on the element substrate 14 using the droplet ejection apparatus 30. The alignment film 24 is then subjected to rubbing, as in the case of the alignment film 27. Subsequently, the seal material 16 is provided on the element substrate 14 and the liquid crystal 17 is arranged in the space encompassed by the seal material 16. The element substrate 14 and the opposed substrate 15 are then bonded together to complete the liquid crystal panel 13.

The illustrated embodiment has the following advantages.

(1) The first droplets Fa are ejected onto the first target positions Ta defined on the opposed substrate 15 in the first ejecting direction Aa, which is inclined at the first tilt angle θa with respect to a normal line of the opposed substrate 15. The second droplets Fb are ejected onto the second target positions Tb, each of which is provided between each adjacent pair of the first target positions Ta, in the second ejecting direction Ab. Thus, the recesses B defined by the first droplets Fa, which spread wet in the first ejecting direction Aa, are filled with the second droplets Fb. This evens the areas corresponding to the recesses B and in the vicinities of the recesses B, thus improving uniformity of the thickness of the alignment film 27.

(2) The second droplets Fb are ejected in the direction different from the first ejecting direction Aa, or the second ejecting direction Ab. In this manner, each of the areas corresponding to the recesses B is filled with the second droplet Fb, which forms a semispherical shape. The second droplet Fb thus spreads wet in the vicinity of the recess B, further effectively evening the area corresponding to the recess B and in the vicinity of the recess B. This further improves the uniformity of the thickness of the alignment film 27.

The second tilt angle θb (the second ejecting direction Ab) is set in correspondence with the first tilt angle θa (the first ejecting direction Aa) with reference to the tilt angle data RD. The second droplets Fb are received by the areas corresponding to the second target positions Tb. Therefore, the areas corresponding to the recesses B and in the vicinities of the recesses B are reliably evened regardless of the shape or the size of each recess B. This reliably improves the uniformity of the thickness of the alignment film 27.

(4) When the opposed substrate 15 is scanned, the translation stage 39b translates the second nozzle-forming surface P4b with respect to the nozzle-forming surface P4a in such a manner that the second droplet receiving positions Pb move along the path defined by the corresponding second target positions Tb. The second droplets Fb ejected from the second nozzles Nb are thus each received by the area (the second target position Tb) between the corresponding adjacent pair of the first droplets Fa. This uniformly evens the areas corresponding to the recesses B and in the vicinities of the recesses B.

(5) As viewed in a normal direction of the opposed substrate 15, the opposed substrate 15 moves along the direction (direction X) opposed to the first ejecting direction Aa. The first droplets Fa thus further effectively spread wet in direction X in accordance with an amount corresponding to the transport velocity V of the opposed substrate 15. This further flattens the first droplets Fa and further improves the uniformity of the thickness of the alignment film 27.

(6) The first ejecting direction Aa of each first nozzle Na is set by tilting the first nozzle-forming surface P4a about the first center of curvature Ca, which is located on the first tilt axis. Similarly, the second ejecting direction Ab of each second nozzle Nb is set by tilting the second nozzle-forming surface P4b about the second center of curvature Cb, which is located on the second tilt axis. In this manner, the first ejecting direction Aa and the second ejecting direction Ab with respect to each first droplet receiving position Pa and each second droplet receiving position Pb, respectively, are set. This reduces variation of the first ejecting directions Aa and variation of the second ejecting directions Ab, suppressing variation of the shapes of the first and second droplets Fa, Fb when the droplets Fa, Fb are received by the opposed substrate 15. The uniformity of the thickness of the alignment film 27 is thus further improved.

(7) Operation of the first tilt stage 40a and the second tilt stage 40b is controlled in accordance with the first tilt data DaD and the second tilt data DbD, respectively. Therefore, the first ejecting direction Aa and the second ejecting direction Ab are set based on the first tilt data DaD and the second tilt data DbD, respectively. This reduces variation of the first ejecting directions Aa and variation of the second ejecting directions Ab, suppressing variation of the shapes of the first and second droplets Fa, Fb when the droplets Fa, Fb are received by the opposed substrate 15.

The illustrated embodiment may be modified in the following forms.

In the illustrated embodiment, the second droplets Fb are ejected with the second tilt stage 40b arranged at the initial position and thus form a semispherical shape. However, the second tilt stage 40b may be held at the tilt position when the second droplets Fb are ejected. In this case, each of the ejected second droplets Fb forms an oval shape extending in direction X. in other words, as long as the areas corresponding to the recesses B receive and become filled with the second droplets Fb, the second tilt stage 40b may be oriented in any suitable manner.

In the illustrated embodiment, as viewed in a normal direction of the opposed substrate 15, the substrate stage 33 is transported along the direction opposed to the first ejecting direction Aa. However, the substrate stage 33 may be moved along the first ejecting direction Aa as viewed in the normal direction of the opposed substrate 15. Alternatively, the carriage 37 may be transported instead of the substrate stage 33.

In the illustrated embodiment, the first tilt mechanism and the second tilt mechanism are embodied as the first tilt stage 40a and the second tilt stage 40b, respectively. However, for example, the substrate stage 33 may be embodied as the first tilt mechanism or the second tilt mechanism and the opposed substrate 15 mounted on the substrate stage 33 may be tilted with respect to the first nozzle-forming surface P4a or the second nozzle-forming surface P4b.

In the illustrated embodiment, the piezoelectric element drive signals COM generated from the common waveform data VD are supplied to the first piezoelectric elements PZa and the second piezoelectric elements PZb. In this manner, the first droplets Fa and the second droplets Fb are each ejected by a predetermined volume. However, for example, the piezoelectric element drive signal COM for each first piezoelectric element PZa and the piezoelectric element drive signal COM for each second piezoelectric element PZb may be produced using different types of waveform data VD in such a manner that the weight of each of the ejected first droplets Fa becomes different from the weight of each of the ejected second droplets Fb. In this case, it is preferred that the weight of each ejected second droplet Fb corresponds to the size of each recess B.

Although the single row of nozzles N is provided in the illustrated embodiment, multiple rows of nozzles N may be employed.

In the illustrated embodiment, the pattern is embodied as the alignment film 27 of the liquid crystal display 10. However, for example, different types of thin films, metal wirings, or color filters of the liquid crystal display 10 or other types of displays may be formed as the pattern. The displays other than the liquid crystal display 10 include, for example, displays having a field effect type device (an FED or an SED). The field effect type device emits light from a fluorescent substance by radiating electrons released by an electron release element onto the fluorescent substance. That is, any suitable pattern may be formed according to the present invention, as long as the pattern is formed by ejected droplets of liquid.

Although the substrate is embodied as the opposed substrate 15 of the liquid crystal display 10, a silicon substrate or a flexible substrate or a metal substrate may be provided as the substrate.

Although the electro-optic device is embodied as the liquid crystal display 10, an electroluminescence device, for example, may be formed as the electro-optic device.

1. A method for forming a pattern on a substrate by ejecting droplets containing a pattern forming material onto the substrate, the method comprising:
ejecting, in a first ejecting direction inclined with respect to a normal line of the substrate, first droplets containing the pattern forming material from a plurality of first ejection ports that are aligned along a certain direction on a surface of the substrate; and
ejecting, in a second ejecting direction and onto areas between adjacent pairs of the first droplets on the substrate, second droplets containing the pattern forming material from a plurality of second ejection ports that are aligned along the certain direction.

2. The method according to claim 1, wherein the second ejecting direction intersects the first ejecting direction.

3. The method according to claim 1, further comprising setting the second ejecting direction in correspondence with the first ejecting direction in such a manner that the second droplets are each received by the corresponding one of the areas between the adjacent pairs of the first droplets.

4. The method according to claim 1, further comprising moving a second ejection port forming surface in which the second ejection ports are formed along the certain direction with respect to a first ejection port forming surface in which the first ejection ports are formed in such a manner that the second droplets are each received by the corresponding one of the areas between the adjacent pairs of the first droplets.

5. The method according to claim 1, further comprising moving the substrate in a direction opposite to the first ejecting direction, as viewed in a normal direction of the substrate, with respect to the first ejection ports.

6. The method according to claim 1, further comprising setting the first ejecting direction by tilting a first ejection port forming surface in which the first ejection ports are formed about a first tilt axis extending along the certain direction.

7. The method according to claim 1, wherein the second ejecting direction is inclined with respect to the normal line of the substrate, and wherein the method further comprises moving the substrate in a direction opposite to the second ejecting direction, as viewed in a normal direction of the substrate, with respect to the second ejection ports.

8. The method according to claim 1, further comprising setting the second ejecting direction by tilting a second ejection port forming surface in which the second ejection ports are formed about a second tilt axis extending along the certain direction.

9. A method for forming an alignment film on a substrate by ejecting droplets containing an alignment film forming material onto the substrate, the method comprising:
ejecting, in a first ejecting direction inclined with respect to a normal line of the substrate, first droplets containing the alignment film forming material from a plurality of first ejection ports that are aligned along a certain direction on a surface of the substrate; and
ejecting, in a second ejecting direction and onto areas between adjacent pairs of the first droplets on the substrate, second droplets containing the alignment film forming material from a plurality of second ejection ports that are aligned along the certain direction.

10. A droplet ejection apparatus that forms a pattern on a substrate by ejecting droplets containing a pattern forming material onto the substrate, the apparatus comprising:
a first ejection port forming surface opposed to the substrate, wherein the first ejection port forming surface includes a plurality of first ejection ports that are aligned in a certain direction on a surface of the substrate, each of the first ejection ports ejecting a first droplet containing the pattern forming material in a first ejecting direction inclined with respect to a normal line of the substrate; and
a second ejection port forming surface opposed to the substrate, wherein the second ejection port forming surface includes a plurality of second ejection ports that are aligned in the certain direction, each of the second ejection ports ejecting a second droplet containing the pattern forming material in a second ejecting direction and onto a corresponding one of areas between adjacent pairs of the first droplets on the substrate.

11. The apparatus according to claim 10, wherein the second ejecting direction intersects the first ejecting direction.

12. The apparatus according to claim 10, further comprising:
a first tilt mechanism that tilts the first ejection port forming surface about a first tilt axis extending along the certain direction;
a first tilt information generating section that generates first tilt information for tilting the first ejection port forming surface in such a manner that the first ejecting direction becomes inclined with respect to a normal line of the substrate; and
a control section that controls operation of the first tilt mechanism in accordance with the first tilt information.

13. The apparatus according to claim 10, further comprising:
a second tilt mechanism that tilts the second ejection port forming surface about a second tilt axis extending along the certain direction;
a second tilt information generating section that generates second tilt information for tilting the second ejection port forming surface in such a manner that the second ejecting direction intersects the first ejecting direction; and
a control section that controls operation of the second tilt mechanism in accordance with the second tilt information.

14. The apparatus according to claim 13, wherein the second tilt information generating section generates the second tilt information in correspondence with the first ejecting direction in such a manner that the second droplets are each received by the corresponding one of the areas between the adjacent pairs of the first droplets.

15. An electro-optic device comprising a substrate having a pattern formed by the droplet ejection apparatus according to claim 10.

16. An alignment film forming apparatus that forms an alignment film on a substrate by ejecting droplets containing an alignment film forming material onto the substrate, the apparatus comprising:
a first ejection port forming surface opposed to the substrate, wherein the first ejection port forming surface includes a plurality of first ejection ports that are aligned in a certain direction on a surface of the substrate, each of the first ejection ports ejecting a first droplet containing the alignment film forming material in a first ejecting direction inclined with respect to a normal line of the substrate; and
a second ejection port forming surface opposed to the substrate, wherein the second ejection port forming surface includes a plurality of second ejection ports that are aligned in a certain direction on a surface of the substrate, each of the second ejection ports ejecting a second droplet containing the alignment film forming material in a second ejecting direction and onto a corresponding one of areas between adjacent pairs of the first droplets on the substrate.

17. A liquid crystal display having a substrate including an alignment film formed by the alignment film forming apparatus according to claim 16.
